(19) United States
(12) Patent Application Publication
(10) Pub. No.: US 2007/0008963 A1
(43) Pub. Date: Jan. 11, 2007

(54) Method to protect against manipulated charging signaling data in IMS networks

(76) Inventor: Klaus Hoffmann, Munchen (DE)

Correspondence Address: Siemens Corporation;Intellectual Property Department, 170 Wood Avenue South, Iselin, NJ, 08830, US

(21) Appl. No.: 11/174,889

(22) Filed: Jul. 5, 2005

(51) Int. Cl. H04L 12/56; H04L 12/28

(52) U.S. Cl. 370/389; 370/401

(57) ABSTRACT

Method to protect against manipulated charging signaling data in IMS networks In the prior art CDR tickets are exchanged between devices/functionalities of an IMS system. This can result in manipulations. The invention reduces the likelihood of manipulation, in that the BGCF function of the IMS system is enhanced such that it accepts the charging-relevant signaling data as per TS 24.229 from the sender only if this was sent by the correct sender.

### FIELD OF INVENTION

The invention relates to a method to protect against manipulated charging signaling data in IMS networks.

### SUMMARY OF THE INVENTION

More recent communication architectures provide for the separation of switching networks into connection-service-related units and for the transportation of the user information (bearer control). This results in a decomposition/separation of connection setup and medium or bearer setup. The user information (switching of the user channel) can in this case be transmitted using various high-bitrate transportation technologies such as ATM, IP or Frame Relay.

Such a separation enables telecommunications services currently conducted in narrowband networks to also be implemented in broadband networks. In this case the users are connected either directly (e.g. using a DSS1 protocol) or via exchanges designed as media gateway controllers (MGC) (e.g. using the ISUP protocol). The user information itself is converted into the transportation technology used in each case via media gateways (MG).

The media gateways are controlled by media gateway controllers (MGC) assigned in each case. In order to control the media gateways the media gateway controllers use standardized protocols, e.g. the MGCP protocol or the H.248 protocol. To communicate with each other the media gateway controllers use a BICC (Bearer Independent Call Control) protocol standardized by the ITU, which is formed from a plurality of standardized protocols and thus comprises a protocol family.

A protocol suitable for the BICC protocol has emerged from the IETF standardization committee in the shape of the SIP protocol (RFC3261) or the add-on SIP-T (RFC3204). The latter—unlike the SIP protocol—enables ISUP messages to be transmitted. The ISUP messages are generally transmitted through tunnels, i.e. through transparent transfer.

The connection setup between two or more SIP users is effected with the aid of SIP protocol elements. Among other things, SDP (Session Description Protocol) data is exchanged here. SDP data is (bearer) end-point-related data containing information on codecs, IP port, IP address, etc. If a connection is to be set up between an SIP user and an H.323 or TDM/ISDN user, these SIP protocol elements must be converted accordingly into H.323, TDM or ISDN protocol elements in the participating media gateway controllers. For example, for a TDM user called from the SIP environment this means that the ISUP messages used in the TDM environment, such as the ISUP message IAM (Initial Address Message) for example, must be created and forwarded thereto.

Initial basic considerations resulted in the standard Q.1912.5 “Interworking SIP and BICC/ISUP” in the ITU-T. Nothing is said there about charging. The function of the BGCF (FIG. 2) is described in section 4.6.4 of the 3GPP specification 3GPP TS 23.228 V6.8.0 (2004-12) and in 3GPP TS 23.002 V6.5.0 (2004-06). In particular an architecture as shown in FIG. 3 is laid down in the IMS (IP multimedia sub-system). This describes how a connection to the terminal of another network operator is established by the SIP terminal UE (User Equipment) of a network operator with the aid of a plurality of functionalities such as for example the BGCF function. CDR-relevant signaling information (charging data record, charging data) is exchanged to this end between the various functionalities.

The CDR information (CDR tickets) contains information on sender and recipient, in other words which users and operators are involved, which network elements are included in the connection path, etc.

The problem is now that exchanging the CDR tickets by intentionally changing the data contained therein represents a potential risk. This possible misuse can arise in that the charging data is manipulated.

The object of the invention is to specify a way in which the risk of misuse when setting up a connection for an SIP terminal across network boundaries can be minimized.

The object is achieved by the claims.

The advantage of the invention is that the charging information (CDR tickets) as per TS 24.229 is not automatically accepted by the BGCF function on receipt. Instead this is made dependent on which unit the SIP signaling message was received from.

The invention is described in greater detail below on the basis of an exemplary embodiment represented in the figures.

### BRIEF DESCRIPTION OF THE DRAWINGS

FIG. 1 shows the basic relationship between two PSTN users, between whom an internet network is arranged,

FIG. 2 shows the description of the BGCF function as per standard TS24.229, and

FIG. 3 shows the IM subsystem as per standard TS24.229.

### DETAILED DESCRIPTION OF THE INVENTION

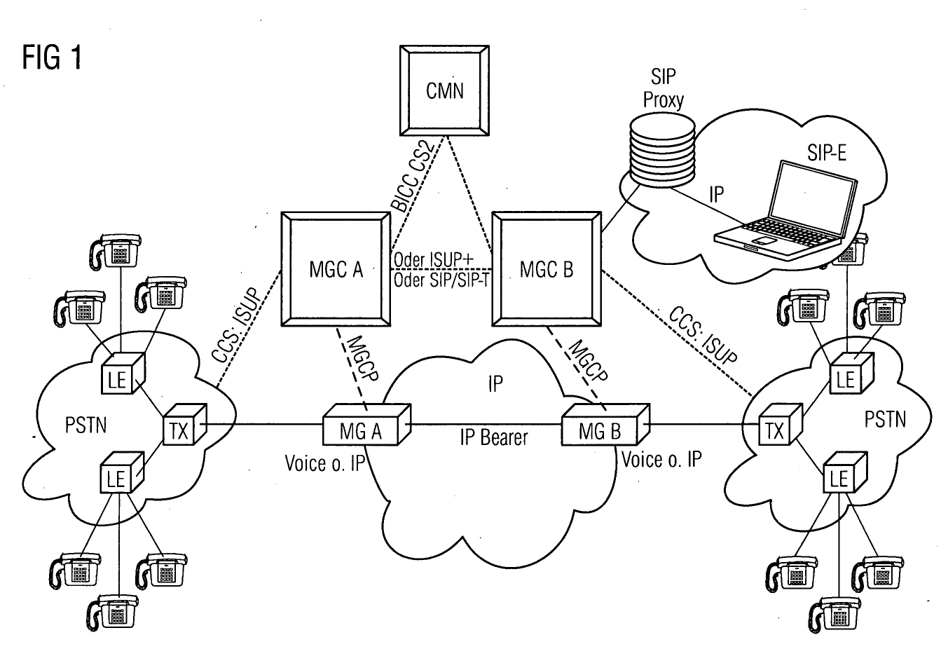

FIG. 1 shows a network configuration on which the inventive method is executed. Two PSTN networks are disclosed here by way of example, in each of which a plurality of PSTN users is arranged in known fashion. These are routed to local exchanges LE, which in turn are connected to transit exchanges TX.

The separation between signaling information and user information is now effected in the transit exchanges TX. The signaling information is fed from the transit exchange TX directly via an ISUP protocol to a media gateway controller MGC (MGC A or MGC B) assigned in each case. The user information is transmitted to an (input-side) media gateway MG (MG A or MG B), which acts as an interface between TDM network and an ATM or IP transmission network and is transmitted in packet-oriented form via the relevant transmission network. The media gateway MG A is controlled by the media gateway controller MGC A in the same way as the media gateway MG B is controlled by the media gateway controller MGC B. If the user information is transmitted from the media gateway MG A to the media gateway MG B the user information is again converted into a TDM data stream under the control of the media gateway controller MGC B assigned to the media gateway MG B and is fed to the PSTN user in question. The data transmitted between the media gateway controller MGC and the media gateway assigned in each case is supported by a standard protocol. This can be the MGCP or the H.248 protocol, for example. The SIP is preferably used between the two media gateway controllers MGC A, MGC B in accordance with the present exemplary embodiment. Further devices such as SIP proxies or SIP units SIP E can be inserted into the signaling path.

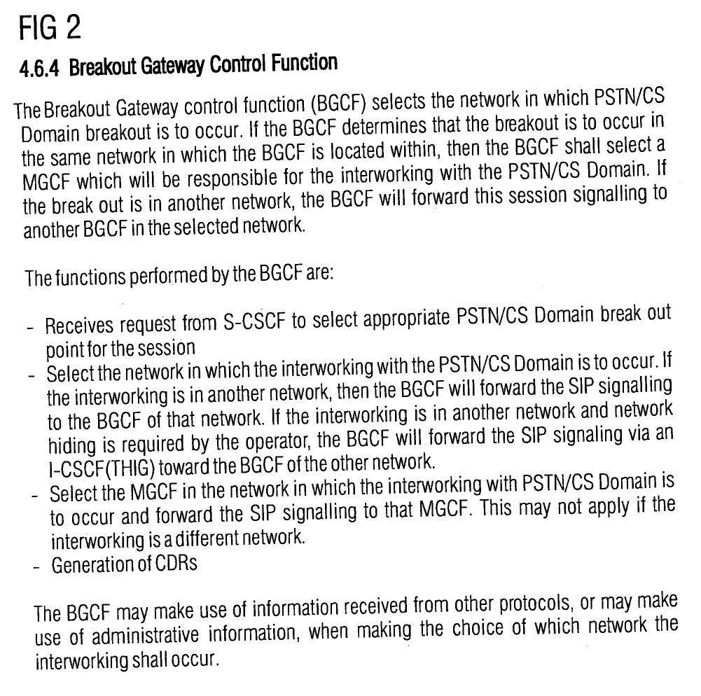

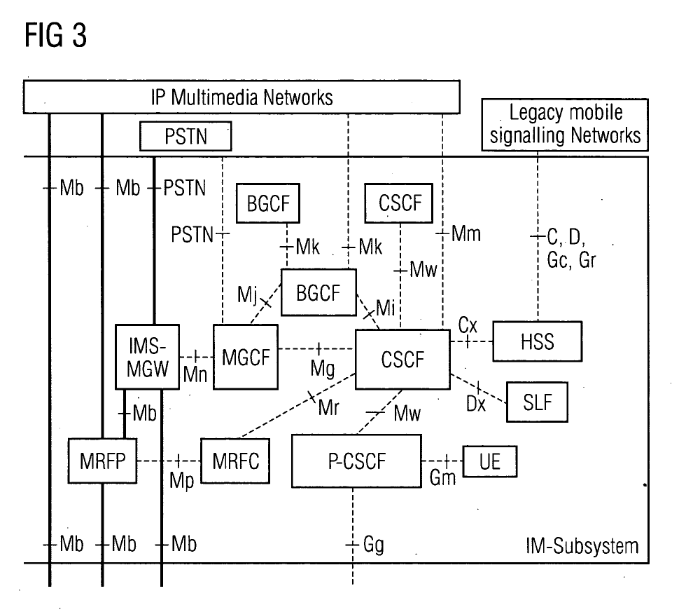

FIG. 2 shows the definition and tasks of the BGCF (breakout gateway control function) functionality as per the 3GPP TS 23.002 V6.5.0 (2004-06) standard. This function is executed on a configuration which is shown in FIG. 3. The device CSCF here represents with the device P-CSCF an SIP proxy, as shown in FIG. 1, while the MGCF functionality is executed in a media gateway controller MGC.

The BGCF function (Breakout Gateway Control Function) selects the network (domain, e.g. PSTN) to which the call outgoing from an SIP terminal UE should be routed. If the BGCF function ascertains that the destination is in its own network, i.e. in the network in which the BGCF function is arranged, the BGCF function selects an MGCF functionality which is responsible for interworking with the PSTN network. If the destination is in another network, the BGCF function forwards the signaling to the other network.

The BGCF function thus has the following tasks:
1. Receipt of the acknowledgement from the serving function S-CSCF to select suitable PSTN networks (domains).
2. Selection of the interconnection point at which the interworking with the PSTN network should take place. If the interworking should take place at another interconnection point, the BGCF function forwards the SIP signaling to the BGCF function of this network.
3. Selection of the MGCF functionality in the network in which the interworking with the PSTN network takes place and forwarding the SIP signaling to this MGCF functionality.
4. Creating the CDR (Charging Data Record, charging data).

The BGCF function can here use either information which it obtains from other protocols or administration information if it determines in which network the interworking should take place.

The invention now provides for the BGCF function to be enhanced such that it additionally does not automatically accept the charging information (CDR tickets) as per TS 24.229 on receipt, but instead carries out a check as a function of which unit the SIP signaling message was received from. The following method steps are performed:
1) The BGCF function receives the charging-relevant signaling data,
2) The BGCF function has a database (local or external) containing entries:
[Entry attribute 1] [Entry attribute 2]
attribute1 [origin address (IP address/domain name/subdomain) of the interconnection point (which here would be MGCF of another network)]
attribute2 [IOI of the operator belonging to the origin address]
3) The BGCF function extracts the origin of the signaling message, e.g. from the SIP VIA header,
4) The BGCF function uses this to search the entries in Entry attribute 1 (i.e. address) in the database,
5) The BGCF function finds an entry and in this line fetches the entry attribute 2 (i.e. IOI (interoperator identifier)),
6) The BGCF function compares e.g. the IOI signaled in SIP with the entry attribute 2 (i.e. IOI).

If the comparison is positive, no manipulation is ascertained (the data in the CDR is interpreted as correct) and the message is sent onward unchanged (as regards charging-relevant data). If the comparison is negative, a manipulation is assumed and an attempt at manipulation exists (if the data has not been/is not being incorrectly administered). The BGCF function then overwrites the received signaling information, here for example IOI, by the entry in attribute 2 and sends this overwritten signaling information internally to the CDR software system with the indication that manipulation had taken place. Externally the correspondingly amended signaling information is forwarded via SIP, so that other units likewise receive the correct information. Alternatively the connection can be cleared down when manipulation is identified.

In this way the receiving operator/network operator is protected against incorrect charging tickets. The proposed solution prevents the relevant network operators from receiving invalid CDRs when using Com Version FMC2.0 (fixed mobile conversion). In particular the checking function described above by way of example is not restricted to a BGCF and interworking with the PSTN, but should also be logically possible for IMS/IMS calls.

1.-10. (canceled)

11. A method for protection against manipulated signaling data in IMS networks, wherein possible data mappings of the IMS networks are stored administratively in a database of a first function of a first network operator, and wherein the data mappings are supplied across network boundaries from a second function of a second network operator to the first network operator, the method comprising:
enhancing the first function so that it only accepts signaling data as per TS 24.229 from a sender, if the sender is a correct sender.

12. The method according to claim 11, wherein the sender is regarded as correct if it is ascertained that the received signaling data is identical to or matches sender-relevant data mappings stored in the database.

13. The method according to claim 11, wherein an attempt at manipulation is assumed if a comparison between the received signaling data and the sender-relevant data mappings stored in the database is not identical or does not match.

14. The method according to claim 13, wherein the first function overwrites and forwards the received signaling data if an attempt at manipulation is assumed.

15. The method according to claim 11, wherein the received signaling data is extracted by the first function from the SIP VIA header of the SIP protocol (RFC3261) or IP header of the IP protocol RFC791.

16. The method according to claim 12, wherein the received signaling data is extracted by the first function from the SIP VIA header of the SIP protocol (RFC3261) or IP header of the IP protocol RFC791.

17. The method according to claim 13, wherein the received signaling data is extracted by the first function from the SIP VIA header of the SIP protocol (RFC3261) or IP header of the IP protocol RFC791.

18. The method according to claim 14, wherein the received signaling data is extracted by the first function from the SIP VIA header of the SIP protocol (RFC3261) or IP header of the IP protocol RFC791.

19. The method according to claim 11, wherein the first function is a BGCF function.

20. The method according to claim 12, wherein the first function is a BGCF function.

21. The method according to claim 11, wherein the second function is a MGCF function.

22. The method according to claim 12, wherein the second function is a MGCF function.

23. The method according to claim 11, wherein, when a manipulation is detected, a notification is sent to a CDR software system that manipulation was present.

24. The method according to claim 12, wherein, when a manipulation is detected, a notification is sent to a CDR software system that manipulation was present.

25. The method according to claim 13, wherein, when a manipulation is detected, a notification is sent to a CDR software system that manipulation was present.

26. The method according to claim 11, wherein, when a manipulation is detected, a notification is sent to other external units that manipulation was present.

27. The method according to claim 12, wherein, when a manipulation is detected, a notification is sent to other external units that manipulation was present.

28. The method according to claim 13, wherein, when a manipulation is detected, a notification is sent to other external units that manipulation was present.

29. The method according to claim 11, wherein, when a manipulation is detected, the connection is cleared down.

30. The method according to claim 13, wherein, when a manipulation is assumed, the connection is disconnected.
